(19) United States
(12) Patent Application Publication
(10) Pub. No.: US 2004/0008703 A1
(43) Pub. Date: Jan. 15, 2004

(54) Asynchronous transfer mode, passive optical network slave device and method for transmitting/receiving data in such device

(76) Inventors: Chan Kim, Daejon (KR); Tae-Whan Yoo, Daejon (KR); Seung-Hwan Kim, Daejon (KR); Je-Soo Ko, Daejon (KR); Jong-Hyun Lee, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/304,153

(22) Filed: Nov. 25, 2002

(30) Foreign Application Priority Data
Jul. 13, 2002 (KR) 2002-40968

(51) Int. Cl. H04L 12/28

(52) U.S. Cl. 370/401

(57) ABSTRACT

Provided are an asynchronous transfer mode, passive optical network (ATM-PON) slave device and a method for transmitting data in the ATM-PON slave device. The device includes an asynchronous transfer mode, passive optical network (ATM-OPN) slave device, the device including a received frame processing unit for receiving and transmitting data; a UTOPIA receiving unit for receiving the data from the received frame receiving unit, storing the data in a FIFO queue, and transmitting the data to an ATM layer; a UTOPIA transmitting unit for receiving the data from the ATM layer, storing the data to at least two FIFO queues according to the rank of data, and transmitting the data; and a transmission frame processing unit for receiving the data from the UTOPIA transmitting unit and transmitting the data to an optical line termination (OLT). Accordingly, one optical network unit (ONU) can have a plurality of traffic containers, and a minimal modification is made to the existing G.983.1 standards, thereby enabling allocation of a plurality of data grants.

### BACKGROUND OF THE INVENTION

1. Field of the Invention

The present invention relates to an asynchronous transfer mode, passive optical network (ATM-PON) slave device, and more particularly, to an ATM-PON slave device that effectively provides high-speed data service to a plurality of subscribers and a method for transmitting/receiving data in the ATM-PON slave device.

2. Description of the Related Art

An asynchronous transfer mode, passive optical network (ATM-PON) has been designed to effectively provide a plurality of subscribers with high-speed data service. The ATM-PON has a structure in which several PONs are installed in one optical line termination (OLT) device, and more than thirty-two or sixty-four optical network units (ONUs) are connected to each PON that is passively branched via a splitter.

FIG. 1 is a block diagram of the structure of a conventional ATM-PON that is passively branched via a splitter 120. Referring to FIG. 1, end users such as several optical network terminations (ONTs) 130 are connected to one optical network unit (ONU) 100. According to the ATM-PON of FIG. 1, downstream data is transmitted to all of the ONUs 100, and each ONU 100 is set to receive only desired data and includes security functions. During transmission of upstream data, an upstream frame is divided into slots and the OLT 100 sends each slot a grant designating ONU 100 to use the slot, since a plurality of ONUs 100 share one line. At this time, a distance between the OLT 110 and the respective ONU 100 and the data processing time of the respective ONU 100 may be different. Therefore, a ranging process, which adjusts a distance between the OLT 100 and the respective ONU 100 to be regular, is used to prevent collision of light while upstream data is being given to the OLT 100.

It is possible to send an ATM data cell, and a physical layer operation and a management (PLOAM) cell downstream or upstream. Prior to communication, each ONU 100 undergoes the ranging process, through which the OLT 110 measures a distance between each ONU 100 and itself and allocates differently delayed bits to all of the ONUs 100 so that the ONUs 100 appear to position at the same point from the OLT 110. During the ranging period, the identification number of and a grant value used by each ONU 100 are also allocated to the corresponding ONU 100. According to the existing ITU-T G.983.1 standards, allocation of a grant value from an ONU 100 is carried out and a message of the grant value is defined in a specific step of the ranging period. Here, only one data grant and one PLOAM grant are allocated to one ONU 100. Also, a mini slot is required to indicate a request for upstream data transmission of each ONU 100 with the number of standby cells. During the ranging period, a divided slot grant value for transmission of the mini slot and information on the location of the mini slot are allocated to each ONU 100.

In addition to the ATM-PON slave device, an upper ATM layer buffers an ATM cell of a large amount. However, such a buffering is not sufficient to properly perform priority-level control required by the ATM-PON. This is because a related ATM cell must be prepared in the ATM-PON slave device before an ATM-PON slave transmitter perceives that it must functions as a specific slot and transmit the ATM cell as specific priority data, since it takes time to take a new cell from the ATM layer and send it as the specific priority data. Therefore, to transmit different priority cells for a plurality of grant values, the ATM-PON slave device further requires a first-in, first-out (FIFO).

### SUMMARY OF THE INVENTION

To solve the above problem, it is one object of the present invention to provide an asynchronous transfer mode, passive optical network (ATM-PON) slave device in which priority-level control is smoothly performed with installation of FIFOs in each priority-level traffic container, and a method for transmitting data in the ATM-OPN slave device.

It is another object of the present invention to provide a computer readable recording medium for recording a program for executing such a method in a computer.

To achieve one aspect of the first object, there is provided an asynchronous transfer mode, passive optical network (ATM-OPN) slave device, the device including a received frame processing unit for receiving and transmitting data; a UTOPIA receiving unit for receiving the data from the received frame receiving unit, storing the data in a FIFO queue, and transmitting the data to an ATM layer; a UTOPIA transmitting unit for receiving the data from the ATM layer, storing the data to at least two FIFO queues according to the rank of data, and transmitting the data; and a transmission frame processing unit for receiving the data from the UTOPIA transmitting unit and transmitting the data to an optical line termination (OLT).

To achieve another aspect of the first object, there is provided a method for allocating a data grant, the method including (a) modifying a grant allocation message to allocate data grants for data of a plurality of ranks to each optical network unit (ONU) in an ATM-PON; and (b) increasing the number of grant fields for the grant allocation message to four at maximum.

### BRIEF DESCRIPTION OF THE DRAWINGS

The above objects and advantages of the present invention will become more apparent by describing in detail a preferred embodiment thereof with reference to the attached drawings in which:

FIG. 1 is a block diagram of the structure of a conventional asynchronous transfer mode, passive optical network (ATM-PON) that is passively branched via a splitter;

FIG. 2 is a block diagram of an optical network apparatus of an electric pole type including an ATM-PON slave device and a user matching device;

FIG. 3 is a block diagram of a home optical network apparatus including an ATM-PON slave device and a home gateway;

FIG. 4 is a block diagram of an ATM-PON slave device;

FIG. 5 is a block diagram of the structure of a UTOPIA transmitting unit of an ATM-PON slave device according to the preset invention; and

FIG. 6 is a table illustrating conventional G.983.1 grant allocation messages; and

FIG. 7 is a table illustrating modified G.981.1 grant allocation messages.

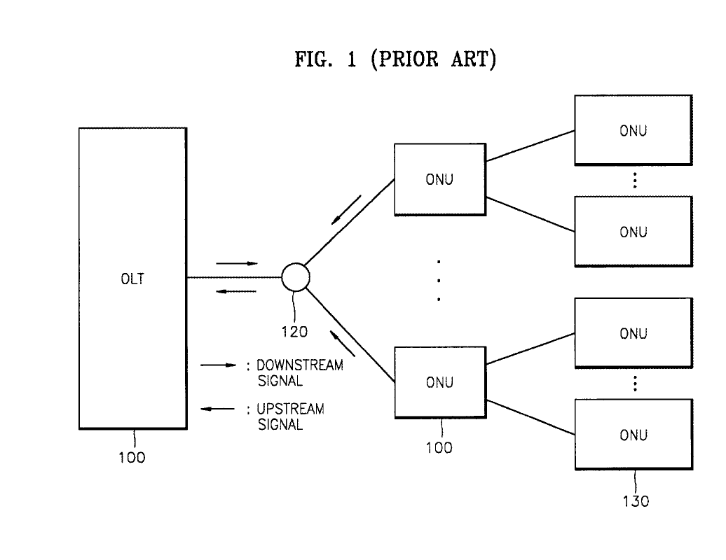

### DETAILED DESCRIPTION OF THE INVENTION

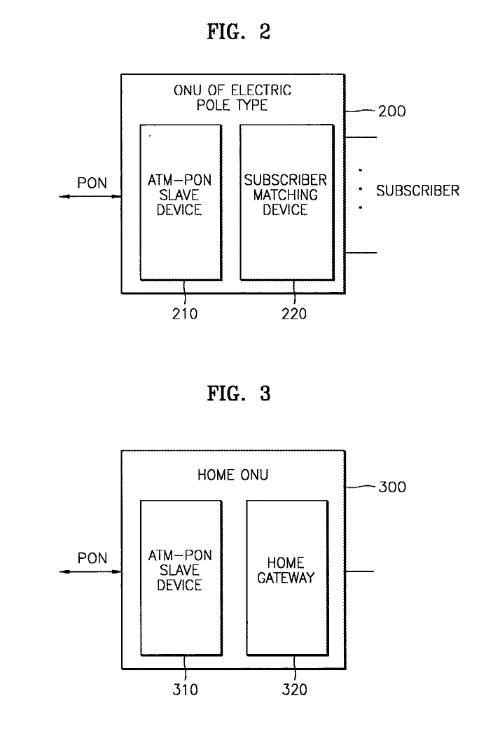

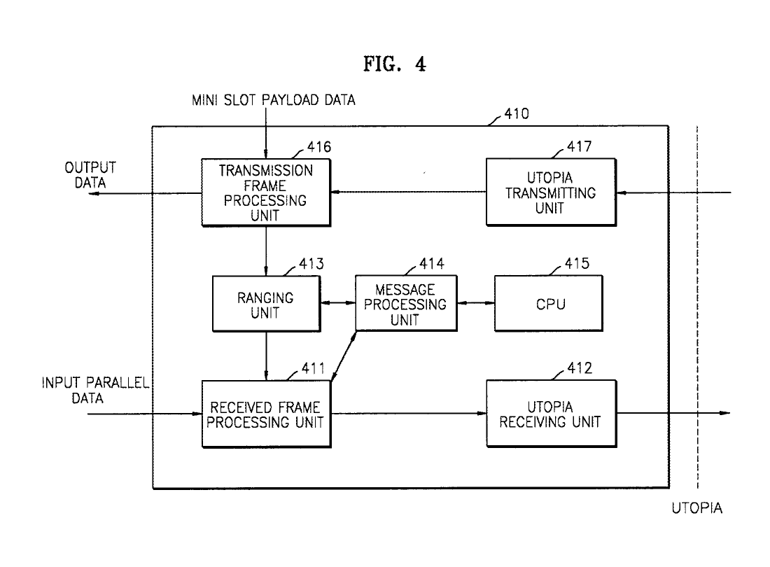

FIG. 2 is a block diagram of an optical network apparatus of an electric pole type including an asynchronous transfer mode, passive optical network (ATM-PON) slave device and a user matching device. FIG. 3 is a block diagram of a home optical network apparatus including an ATM-PON slave device and a home gateway. FIG. 4 is a block diagram of an ATM-PON slave device 417.

Referring to FIG. 4, a received frame processing unit 411 receives input parallel data from a parallel bite stream and checks the header of an ATM cell of the data to classify the received data cell into a physical layer operation and management (PLOAM) cell and a general user cell. Messages contained in the received data cell are transmitted to a message processing unit 414, ranged by a ranging unit 413, and transmitted to a central processing unit (CPU) 415. General user cells of the received data cells are transmitted to an ATM layer via a UTOPIA receiving unit 412.

A transmission frame processing unit 416 stores the ATM cell, which is transmitted from the UTOPIA transmitting unit 417, in a FIFO queue. If the transmission frame processing unit 416 is required to send a data cell as a result of decoding a grant value, it reads the data cell from a related FIFO queue and outputs the data cell. In case of transmitting a PLOAM cell, the transmission frame processing unit 416 makes' and outputs the PLOAM cell, using a message from a message generating block and patterns of a laser control field (LCF) and a receiver control field (RXCF).

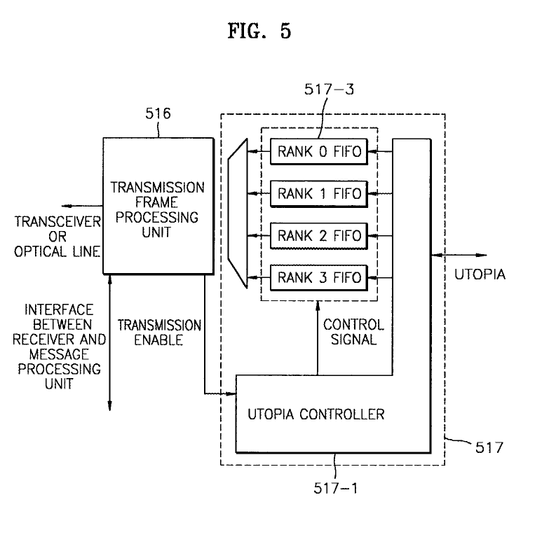

FIG. 5 is a block diagram of the structure of a UTOPIA transmitting unit 517 of an ATM-PON slave device according to the preset invention. The UTOPIA transmitting unit 517 includes a UTOPIA controller 517-1 that governs control between a UTOPIA and the UTOPIA transmitting unit 517, two or more FIFOs 517-3 that store priority ATM cells, and a transmission frame processing unit 516 that transmits data upward in accordance with slot timing.

While the ATM-PON is in an operational mode, information regarding the number of upstream data cells, which are on standby in an ONU, is sent to an OLT via a mini slot upon a request of the OLT. The frequency of sending the mini slot depends on the frequency of a divided slot grant transmitted from the OLT. The mini slot holds information regarding the number of ATM cells to be sent. According to newly set G.983.3 standards, it is possible to upload such information corresponding to grants of several ranks. That is, each ONU requests the OLT to send it sufficient grants for data transmission via the mini slot. The request for grants would be included in data in certain format written by a CPU or be made in real-time by hardware via an interface of the UTOPIA transmitting unit 517. If the request is made by a CPU, the CPU reads the number of cells present in one, which is to be transmitted in the upper direction of the ATM-PON, among several queues managed by an ATM layer, and records the number on a register in an ATM-PON slave device in predetermined format. Then, the ATM-PON slave device sends data containing the mini slot when transmitting the mini slot upstream. Irrespective of whether data regarding the request for grants is made by a CPU or by hardware via the interface, information regarding both an outer ATM-layer buffer of a large capacity and a buffer in an ATM-PON slave UTOPIA must be contained in the data.

If the OLT transmits a traffic container (TC) or a grant of a rank as per the request for grants, the transmission frame processing unit 516 checks allocation of a desired grant value to a related slot and sends the UTOPIA transmitting unit 517 a request for sending a data cell, together with information of the corresponding rank. Next, the UTOPIA transmitting unit 517 reads a data cell from a corresponding FIFO queue 517-3 and transmits to a transmission frame processing unit (516). However, in the event that the corresponding FIFO queue 517-3 has no data cell of a proper rank, another cell of lower priority (a cell of a best effort rank) may be transmitted. If there is no cell in the corresponding FIFO queue 517-3, an idle cell is transmitted.

In this disclosure, the FIFOs 517-3 in the UTOPIA transmitting unit 517 of the ATM-PON slave device do not have large capacities but are used to store data in advance for a delay in time spent in transmitting a data cell from an ATM layer to the UTOPIA transmitting unit 517. If there is an ATM cell to be sent to an ONU or there is an ATM cell outside the ATM-PON slave device, e.g., in a buffer included in an ATM-layer processing circuit, the ATM cell must be transferred to one of the FIFOs 517-3 in the UTOPIA transmitting unit 517 as soon as possible. This enables to select an ATM-PON slave from a specific slot and transmit a data cell of a specific rank without delay.

In universal test & operations PHY (physical layer) interface for ATM (UTOPIA) I or II, when an ATM layer asks about whether it may transmit a cell to a physical layer, which corresponds to an ATM-PON slave according to the present invention, a response to the inquiry comes from the physical layer. In general, the ATM layer regards an ATM-PON slave device as one port because the ATM-PON slave device is connected to only one line, and therefore sends an inquiry into whether a port to which data is to be transmitted can receive a data cell or not, without information on the rank of data the ATM layer will transmit to the physical layer. In case of the UTOPIA II, this inquiry is transferred to a plurality of physical layer (PHY) devices, using a polling method. In case of the UTOPIA I, this inquiry is grasped by observing a private signal.

In the UTOPIA II, if the rank of a data cell, which is to be transmitted from an ATM layer to a PHY device, is known to the PHY device when the ATM layer makes the inquiry using the polling method, the PHY device can responds to the inquiry according to information stored in a related FIFO. However, according to the UTOPIA specification, this is in fact impossible because the ATM layer is set to only ask if a port can receive the data cell. To solve this problem, there are two ways of: (i) setting the PHY device to respond to the ATM layer that the PHY device can receive data from the ATM layer, only when each of the FIFOs of all ranks has at least one room for receiving the data; and (ii) setting an ATM-PON slave device to have at least two UTOPIA addresses, and FIFOs of all ranks to have different port addresses. Using one of the above two ways, although data of all ranks is transmitted upstream via on optical line, the ATM layer considers the respective ranks of the ATM-PON slave device as different ports and as a result, the ATM-PON slave device can operate as several ports. In general, the ATM layer can freely adjust output ports and ranks of all connections by connection setting.

In case that the ATM-PON slave device has FIFOs of different port numbers, it is apparent that which FIFO an ATM cell is to be stored in when the ATM cell is given to the ATM-PON slave device. However, if FIFOs are not classified by port numbers, a HEC (full name?) or universal disc format (UDF) part of a 16-bit UTOPIA may be indicated with cell ranks so that an ATM cell can be transmitted to a related FIFO. For both cases, the UTOPIA controller 517-1 receives a cell from an ATM layer, stores the cell to a related FIFO, and manages the number of data stored in each FIFO. During these operations, the UTOPIA controller 517-1 also reads data from a related FIFO and transmits the data to the transmission frame processing unit 516 as per request of the transmission frame processing unit 516.

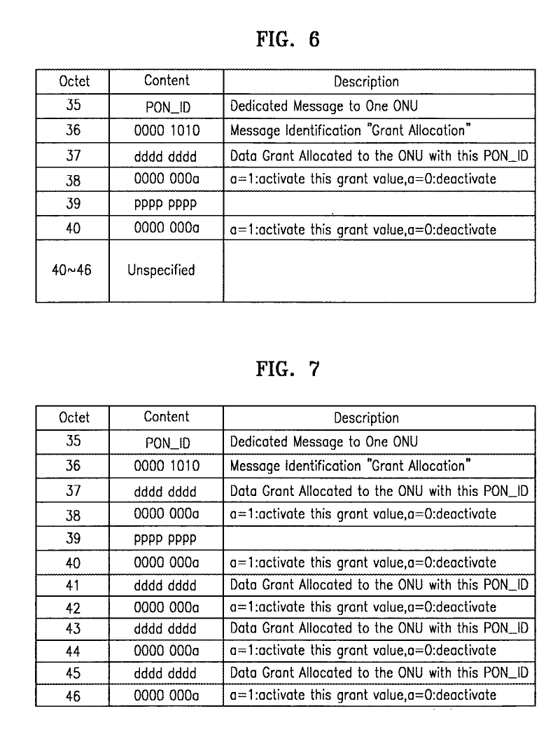

FIG. 6 is a table illustrating conventional G.983.1 grant allocation messages. FIG. 7 is a table illustrating modified G.981.1 grant allocation messages. According to the G.983.1 standards, an ONU shall be allocated with a grant only in a 05 state during a ranging period, and an OLT shall not send a grant allocation message to the ONU during the operation of the ONU. Even if a grant allocation message is sent to the ONU which is operating, the ONU does not process this message. A method for allocating two or more grants to each ONU is required to make one ONU have several data grant values, make a request for and allocation of a grant with respect to data of several ranks, and prevent a loss in time and cells in a traffic, which is sensitive to time, by an ATM-PON. The allocation of two or more grants to each ONU is possible by adding some functions to the G.983.1 standards (the existing G.983.3 standards do not teach or suggest the above allocation method). According to the present invention, a modification is made to grant allocation messages contained in the existing G.983.1 standards, which is illustrated in a table of FIG. 6. As a result, as shown in a table of FIG. 7, additional data grants are allocated to bites 41-46.

The present invention can be embodied as a computer readable code in a computer readable medium. Here, the computer readable medium may be any recording apparatus capable of storing data that can be read by a computer system, e.g., a read-only memory (ROM), a random access memory (RAM), a compact disc (CD)-ROM, a magnetic tape, a floppy disk, a hard disc, flash memory, an optical data storage device, and so on. Also, the computer readable medium may be a carrier wave that transmits data via the Internet, for example. The computer readable recording medium can be dispersively installed in a computer system connected to a network, and stored and accomplished as a computer readable code by a distributed computing environment.

While this invention has been particularly shown and described with reference to preferred embodiments thereof, it will be understood by those skilled in the art that various changes in form and details may be made therein without departing from the spirit and scope of the invention as defined by the appended claims.

As described above, according to the present invention, an ATM-PON slave device can set a plurality of traffic containers with respect to one ONU, and further, a minimal modification is made to the existing G.983.1 standards, thereby allocating a plurality of data grants to OLTs. Also, the ONU can be given a grant and responds to the grant via an outer large-capacity buffer of an ATM layer and using a ATM-PON DBA method or a media access control (MAC) method.

What is claimed is:

1. An asynchronous transfer mode, passive optical network (ATM-OPN) slave device, the device comprising:
a received frame processing unit for receiving and transmitting data;
a UTOPIA receiving unit for receiving the data from the received frame receiving unit, storing the data in a FIFO queue, and transmitting the data to an ATM layer;
a UTOPIA transmitting unit for receiving the data from the ATM layer, storing the data to at least two FIFO queues according to the rank of data, and transmitting the data; and
a transmission frame processing unit for receiving the data from the UTOPIA transmitting unit and transmitting the data to an optical line termination (OLT).

2. The device of claim 1, wherein the FIFO queues are classified by their ranks and allocated with different port addresses in a UTOPIA.

3. The device of claim 1, wherein the FIFO queues are classified by their ranks but are not allocated with different port addresses in a UTOPIA, a HEC or universal disc format (UDF) part of the UTOPIA is indicated with cell ranks so that an ATM cell can be transmitted to a related FIFO queue, and
a physical layer responds to the ATM layer that it can receive a data cell only if every FIFO queue has at least one room for receiving the data cell, when an ATM layer inquires into whether or not the physical layer can receive the data cell, using a polling method.

4. A method for allocating a data grant, comprising:
(a) modifying a grant allocation message to allocate data grants for data of a plurality of ranks to each optical network unit (ONU) in an ATM-PON ; and
(b) increasing the number of grant fields for the grant allocation message to four at maximum.

5. A computer readable recording medium for recording a program for executing a method of claim 4 in a computer.
